(19) United States
(12) Patent Application Publication
(10) Pub. No.: US 2016/0276840 A1
(43) Pub. Date: Sep. 22, 2016

(54) CHARGING RELAY DEVICE AND CHARGING RELAY METHOD

(71) Applicant: Kabushiki Kaisha Toshiba, Tokyo (JP)

(72) Inventor: Junjiro OTO, Yokohama Kanagawa (JP)

(21) Appl. No.: 14/822,059

(22) Filed: Aug. 10, 2015

(30) Foreign Application Priority Data
Mar. 17, 2015 (JP) 2015-053195

(51) Int. Cl. H02J 5/00; H02J 7/02; H02J 17/00

(52) U.S. Cl. CPC H02J 5/005; H02J 17/00; H02J 7/025

(57) ABSTRACT

A charging relay device of the embodiments has a power receiving unit, a power transmitting unit and a communication protocol converting unit. The power receiving unit is capable of receiving power according to first standard. The power transmitting unit is capable of transmitting power according to second standard that is different from the first standard. The communication protocol converting unit converts a communication protocol complying with the first standard into a communication protocol complying with the first standard.

### CROSS REFERENCE TO RELATED APPLICATION

This application is based upon and claims the benefit of priority from the prior Japanese Patent Application No. 2015-53195 filed on Mar. 17, 2015; the entire contents of which are incorporated herein by reference.

### FIELD

Embodiments described herein relate generally to a charging relay device and a charging relay method.

### BACKGROUND

Conventionally, a mobile terminal such as a mobile phone and a smartphone is provided with a rechargeable battery. When a battery of such a mobile terminal is charged, a user has to connect one end of a charging apparatus to a commercial power supply and connect a terminal provided at the other end of the charging apparatus, which is troublesome.

Therefore, in recent years, a wireless power feeding technique has been utilized. For example, power can be fed to a mobile terminal only by placing the mobile terminal incorporating a wireless power receiving function on a wireless power transmitter.

However, there are a plurality of standard setting organizations of wireless power feeding, such as WPC (Wireless Power Consortium), PMA (Power Matters Alliance) and A4WP (Alliance for Wireless Power), which have respectively proceeded with standardization. Therefore, power cannot be wirelessly fed to devices complying with different standards.

That is, a power transmitter supporting standard A cannot feed power to power receivers other than a power receiver complying with standard A due to a difference in a communication protocol, or the like. Further, a power transmitter supporting standard B cannot feed power to power receivers other than a power receiver complying with standard B due to a difference in a communication protocol, or the like. Therefore, there is limitation in wireless power feeding.

### BRIEF DESCRIPTION OF THE DRAWINGS

FIG. 1 is a diagram illustrating a configuration of a wireless power feeding system according to a first embodiment;

FIG. 2 is a diagram illustrating a detailed circuit configuration of a charging relay device according to the first embodiment;

FIG. 3 is a flowchart for explaining an example of flow of charging relay processing using a charging relay device 4 of the first embodiment;

FIG. 4 is a diagram illustrating a configuration of a wireless power feeding system according to a modification of the first embodiment;

FIG. 5 is a diagram illustrating a detailed circuit configuration of a charging relay device according to a second embodiment; and

FIG. 6 is a flowchart for explaining an example of flow of charging relay processing using a charging relay device 4b of the second embodiment.

### DETAILED DESCRIPTION

A charging relay device of embodiments has a power receiving unit, a power transmitting unit and a communication protocol converting unit. The power receiving unit can receive power according to a first standard. The power transmitting unit can transmit power according to a second standard that is different from the first standard. The communication protocol converting unit converts a communication protocol complying with the second standard into a communication protocol complying with the first standard.

Embodiments will be described in detail below with reference to the drawings.

### First Embodiment

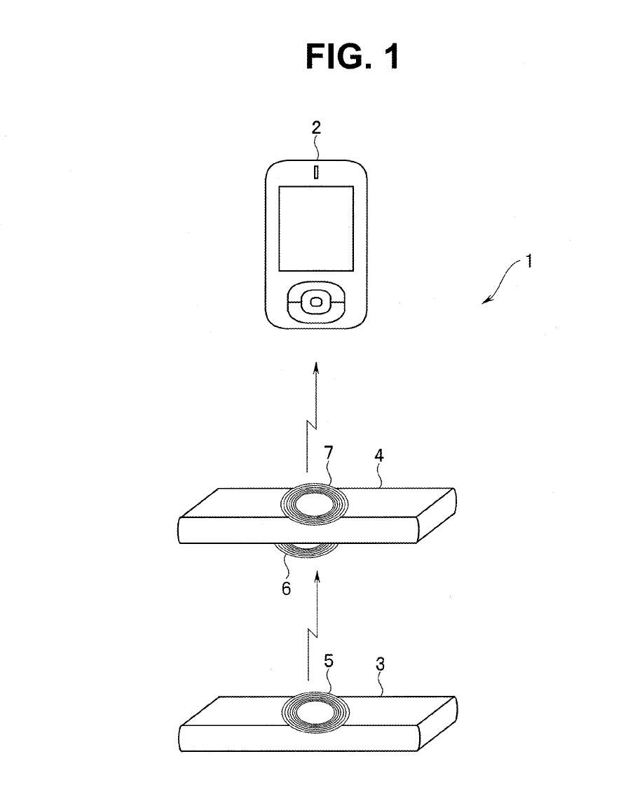

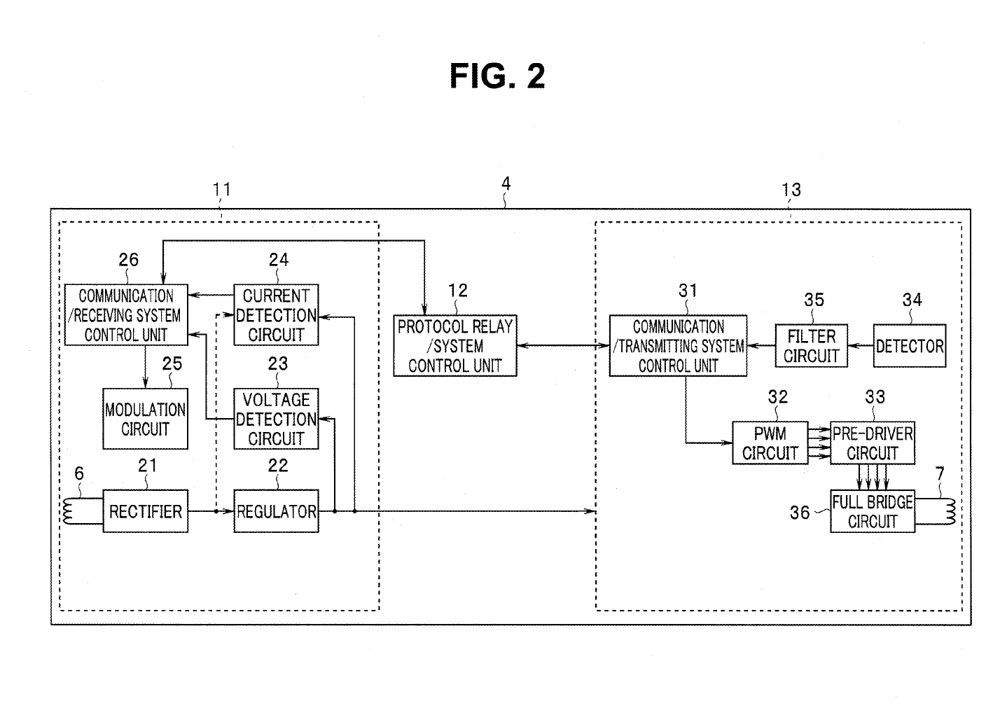

First, a configuration relating to a wireless power feeding system according to a first embodiment will be described based on FIG. 1 and FIG. 2. Note that part of functions relating to the wireless power feeding system in the configuration in the embodiment will be selectively described.

FIG. 1 is a diagram illustrating a configuration of the wireless power feeding system according to the first embodiment, and FIG. 2 is a diagram illustrating a detailed circuit configuration of a charging relay device according to the first embodiment.

A wireless power feeding system 1 of the embodiment is configured to include a mobile terminal 2 such as a mobile phone and a smartphone, having a wireless power receiving function, a power transmitter 3 having a wireless power transmitting function, and a charging relay device 4 having a wireless power receiving function and a wireless power transmitting function.

The standard (power feeding standard) of wireless power feeding of the mobile terminal 2 which is a device to be charged supports standard B. On the other hand, the standard of wireless power feeding of the power transmitter 3 supports standard A. As will be described later, the charging relay device 4 includes a receiving system (power receiving unit) supporting standard A, and a transmitting system (power transmitting system) supporting standard B.

The power transmitter 3 supporting standard A can transmit power from a transmission coil 5. The charging relay device 4 which includes a reception coil 6 and a transmission coil 7, receives power transmitted from the transmission coil 5 of the power transmitter 3. When the charging relay device 4 receives power from the power transmitter 3 at the reception coil 6, the charging relay device 4 performs power supply according to standard B from the transmission coil 7 to the mobile terminal 2. The mobile terminal 2 which supports standard B receives power from the charging relay device 4 and charges a battery which is not illustrated.

Note that while, as illustrated in FIG. 1, the charging relay device 4 is configured such that the reception coil 6 and the transmission coil 7 are disposed at different faces, the arrangement is not limited to this, and, for example, the charging relay device 4 may be configured such that the reception coil 6 and the transmission coil 7 are disposed at the same face.

As illustrated in FIG. 2, the charging relay device 4 is configured to include a receiving system 11, a protocol relay/system control unit 21 and a transmitting system 13. Note that the receiving system 11, the protocol relay/system control unit 12 and the transmitting system 13 may be configured in the same block or may be configured in the respective individual blocks.

The receiving system 11 is configured to include a rectifier 21, a regulator 22, a voltage detection circuit 23, a current detection circuit 24, a modulation circuit 25 and a communication/receiving system control unit 26, in addition to the above-described reception coil 6.

Further, the transmitting system 13 is configured to include a communication/transmitting system control unit 31, a PWM circuit 32, a pre-driver circuit 33, a detector 34, a filter circuit 35 and a full bridge circuit 36, in addition to the above-described transmission coil 7.

When wireless power feeding is started, the mobile terminal 2 requests the charging relay device 4 to wirelessly feed power using a communication protocol complying with standard B. This request is detected by the detector 34 of the charging relay device 4, and transmitted to the protocol relay/system control unit 12 via the filter circuit 35 and the communication/transmitting system control unit 31.

The protocol relay/system control unit 12 configuring a communication protocol converting unit converts a communication protocol complying with standard B into a communication protocol complying with standard A, and outputs the request whose communication protocol has been converted into the communication protocol complying with standard A to the communication/receiving system control unit 26. The communication/receiving system control unit 26 outputs this request to the modulation circuit 25.

The modulation circuit 25 which is a circuit configured to modulate data (request) to be transmitted to the power transmitter 3, performs, for example, ASK (amplitude-shift keying) modulation. The data subjected to ASK modulation is transmitted from the reception coil 6 to the transmission coil 5.

The power transmitter 3 is connected to, for example, a commercial power supply for home use via an AC adapter which is not illustrated. When the power transmitter 3 causes an alternating current to flow to the transmission coil 5 so as to feed power according to the request (communication data) from the charging relay device 4, a magnetic flux is generated at the transmission coil 5. This magnetic flux causes an alternating current to also flow to the reception coil 6 of the charging relay device 4, so that power is wirelessly fed.

The rectifier 21 rectifies the alternating current received at the reception coil 6 and supplies the current to the regulator 22. The regulator 22 which is configured with a LDO (low drop out) regulator, a DCDC converter, or the like, is a circuit configured to regulate power rectified by the rectifier 21. The regulator 22 supplies the regulated power to the transmitting system 13. Note that it is also possible to directly supply power rectified by the rectifier 21 to the transmitting system 13 without the regulator 22 being provided.

The voltage detection circuit 23 monitors and measures an output voltage from the regulator 22 and outputs the measurement result to the communication/receiving system control unit 26. The current detection circuit 24 monitors and measures an output current from the regulator 22 and outputs the measurement result to the communication/receiving system control unit 26. Note that the current detection circuit 24 may be configured to monitor and measure a current corresponding to the output current from the regulator 22, here, the current rectified by the rectifier 21 as indicated by a dashed line in FIG. 2.

The communication/receiving system control unit 26 can compute output power being output to the transmitting system 13 based on the measurement result of the voltage detection circuit 23 and the measurement result of the current detection circuit 24, and can transmit information for providing an instruction of increasing or decreasing reception power, or the like, to the power transmitter 3 via the modulation circuit 25 and the reception coil 6 while taking into account information from the protocol relay/system control unit 12.

The power from the regulator 22 is supplied to the PWM circuit 32 via the communication/transmitting system control unit 31. This power is driven by the pre-driver circuit 33 after being subjected to PWM control by the PWM circuit 32, and supplied to the full bridge circuit 36. The communication/transmitting system control unit 31 controls transmission power by controlling the PWM circuit 32 based on the information transmitted from the mobile terminal 2 which is a power receiving side.

The full bridge circuit 36 converts power from the regulator 22 from a direct current to an alternating current, and supplies the current to the transmission coil 7. By this means, the alternating current flows to the transmission coil 7, thereby a magnetic flux is generated. As a result, an alternating current also flows to a reception coil, which is not illustrated, of the mobile terminal 2, so that power is wirelessly fed.

While an electromagnetic induction type, which is currently most common, will be described as a wireless power feeding method in the wireless power feeding system 1 of the embodiment, the present invention is not limited to this, and other types, for example, a magnetic resonance type, an electric field coupling type, or a micro-wave type can be used.

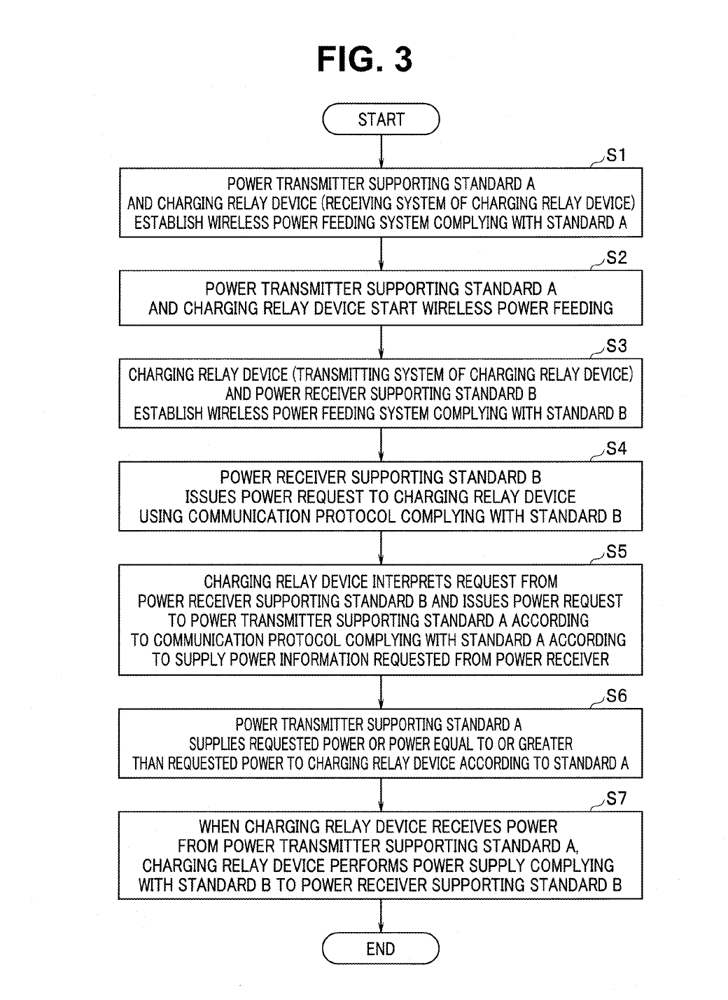

Charging relay processing of the charging relay device 4 configured as described above will be described next. FIG. 3 is a flowchart for explaining an example of flow of the charging relay processing using the charging relay device 4 according to the first embodiment. Note that, in the following description, the power receiver corresponds to the mobile terminal 2.

First, the power transmitter 3 supporting standard A and the charging relay device 4 (receiving system 11 of the charging relay device 4) establish a wireless power feeding system complying with standard A (step S1). Then, the power transmitter 3 supporting standard A and the charging relay device 4 start wireless power feeding (step S2).

Subsequently, the charging relay device 4 (transmitting system 13 of the charging relay device 4) and the power receiver supporting standard B establish a wireless power feeding system complying with standard B (step S3). The power receiver supporting standard B issues a power request to the charging relay device 4 using a communication protocol complying with standard B (step S4).

The charging relay device 4 interprets the request from the power receiver supporting standard B and issues a power request to the power transmitter 3 supporting standard A with a communication protocol complying with standard A according to supply power information requested from the power receiver (step S5).

As described above, in the processing of step S5, processing of converting a communication protocol complying with standard B into a communication protocol complying with standard A is performed. Further, because wireless power feeding is relayed by the charging relay device 4, there is a case where power loss occurs in the charging relay device 4. Therefore, the charging relay device 4 requests power equal to or greater than power requested by the power receiver to the power transmitter 3.

Subsequently, the power transmitter 3 supporting standard A supplies requested power or power equal to or greater than the requested power to the charging relay device 4 according to standard A (step S6). Finally, when the charging relay device 4 receives power from the power transmitter 3 supporting standard A, the charging relay device 4 performs power supply complying with standard B to the power receiver supporting standard B (step S7), and the processing is finished.

As described above, the charging relay device 4 converts the communication protocol complying with standard B from the mobile terminal 2 supporting standard B into the communication protocol complying with standard A, and performs transmission to the power transmitter 3 supporting standard A. As a result, the power transmitter 3 can transmit power according to the power request from the mobile terminal 2 supporting different standards. The charging relay device 4 can receive this power and transmit power to the mobile terminal 2 according to the standard of mobile terminal 2.

Therefore, according to the charging relay device of the embodiment, it is possible to enable wireless power feeding even between wireless power feeding devices supporting different standards.

### (Modification)

A modification of the first embodiment will be described.

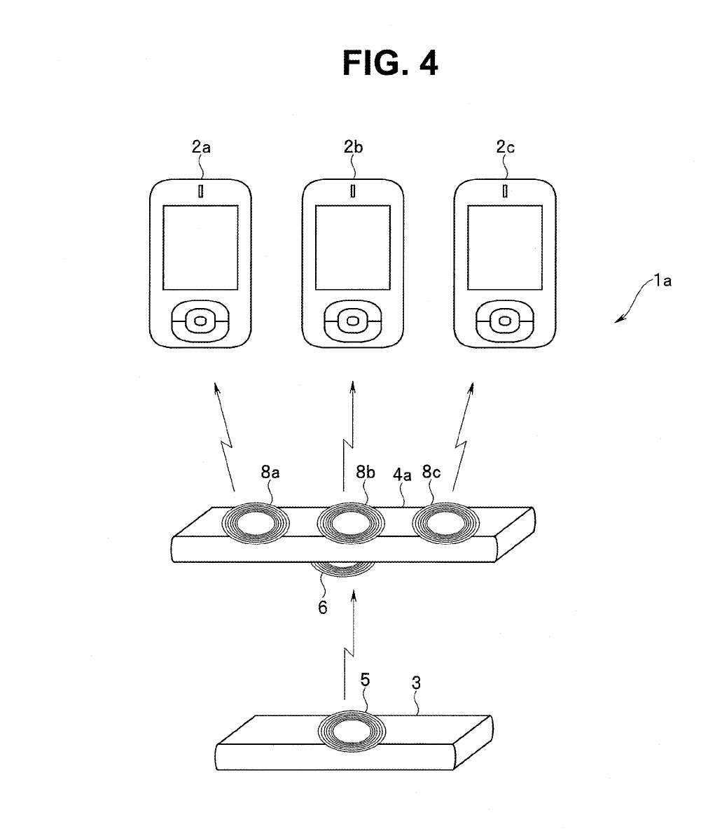

FIG. 4 is a diagram illustrating a configuration of a wireless power feeding system according to the modification of the first embodiment. Note that, in FIG. 4, the same reference numerals will be assigned to the same components as those in FIG. 1, and explanation thereof will be omitted.

As illustrated in FIG. 4, the wireless power feeding system 1a is configured with a charging relay device 4a instead of the charging relay device 4 in FIG. 1.

The charging relay device 4a is configured to include a transmission coil 8a of a transmitting system supporting standard A, a transmission coil 8b of a transmitting system supporting standard B, and a transmission coil 8c of a transmitting system supporting standard C.

This charging relay device 4a can wirelessly feed power to a mobile terminal 2a supporting standard A from the transmission coil 8a of the transmitting system supporting standard A. The charging relay device 4a can wirelessly feed power to a mobile terminal 2b supporting standard B from the transmission coil 8b of the transmitting system supporting standard B. Further, the charging relay device 4a can wirelessly feed power to a mobile terminal 2c supporting standard C from the transmission coil 8c of the transmitting system supporting standard C. Note that while the charging relay device 4a is provided with transmission coils supporting the respective standards, the present invention is not limited to this. That is, if a transmission coil can be made sharable even with different standards, it is possible to share the transmission coil.

The above-described charging relay device 4 of the first embodiment wirelessly feeds power only to the mobile terminal 2 supporting standard B from the power transmitter 3 supporting standard A. On the other hand, the charging relay device 4a of the modification can wirelessly feed power to the mobile terminal 2a supporting standard A, the mobile terminal 2b supporting standard B or the mobile terminal 2c supporting standard C from the power transmitter 3 supporting standard A.

Note that while the charging relay device 4a is configured to include three transmission coils 8a, 8b and 8c, the number of transmission coils is not limited to three. For example, the charging relay device 4a may be configured to include four or more transmission coils supporting different standards, so that power can be wirelessly fed to four or more mobile terminals supporting different standards.

Further, the charging relay device 4a may distribute power from the power transmitter 3 among the transmission coils 8a, 8b and 8c, so that power is wirelessly fed to a plurality of mobile terminals 2a, 2b and 2c supporting different standards at the same time. That is, the charging relay device 4a is configured to wirelessly feed power to the mobile terminal 2a supporting standard A, the mobile terminal 2b supporting standard B and the mobile terminal 2c supporting standard C at the same time.

Further, while the charging relay device 4a receives power wirelessly fed from the power transmitter 3 supporting standard A at the reception coil 6, the charging relay device 4a may include a plurality of reception coils, and may wirelessly feed power from power transmitters other than the power transmitter supporting standard A. Note that if a reception coil can be made sharable even with different standards, the charging relay device 4a can receive power at one reception coil from power transmitters supporting different standards.

### Second Embodiment

The second embodiment will be described next.

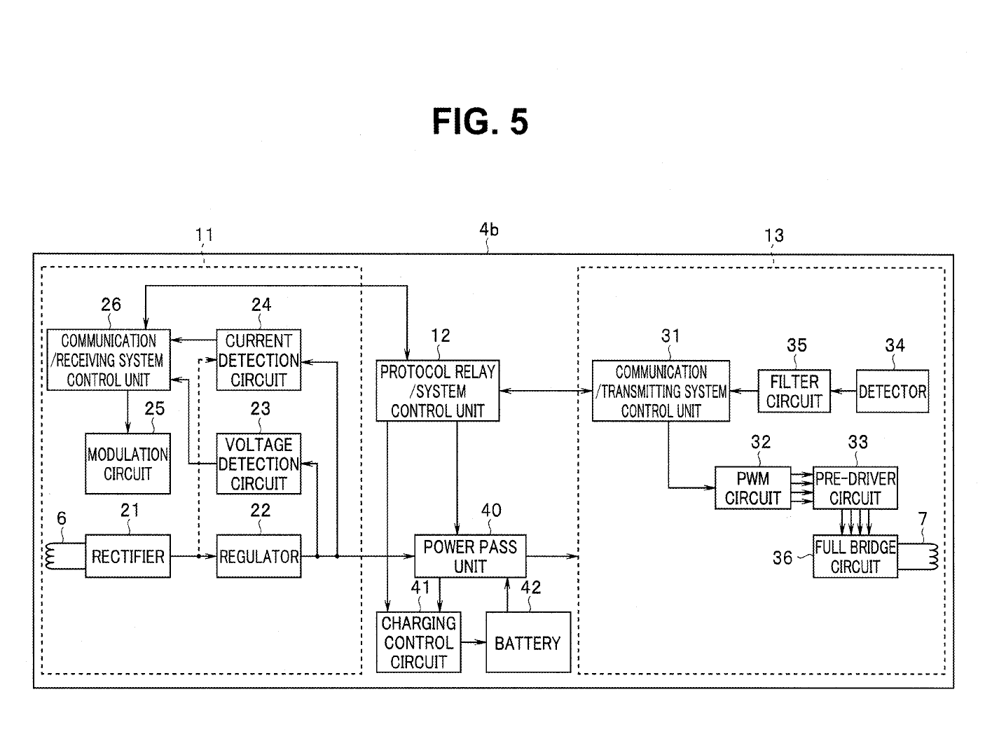

FIG. 5 is a diagram illustrating a detailed circuit configuration of a charging relay device according to the second embodiment. Note that in FIG. 5, the same reference numerals will be assigned to the same components as those in FIG. 2, and explanation thereof will be omitted.

As illustrated in FIG. 5, the charging relay device 4b of the embodiment is configured by adding a power pass unit 40, a charging control circuit 41 and a battery 42 to the charging relay device 4 in FIG. 2. Note that, while the battery 42 is, for example, a lithium-ion secondary battery, the battery 42 is not limited to a lithium-ion secondary battery, and other types of secondary batteries may be used.

The power from the regulator 22 is supplied to the power pass unit 40. The power pass unit 40 supplies this power to the charging control circuit 41. The charging control circuit 41 charges the battery 42 with the supplied power under control by the protocol relay/system control unit 12.

When a power request is transmitted from the mobile terminal 2, the protocol relay/system control unit 12 controls the power pass unit 40 to supply power charged in the battery 42 to the power pass unit. The power pass unit 40 supplies this power to the transmitting system 13 to wirelessly feed power to the mobile terminal 2.

As described above, in the embodiment, wireless power feeding between the charging relay device 4b and the mobile terminal 2 supporting standard B are performed using the battery 42 of the charging relay device 4b as a power supply source.

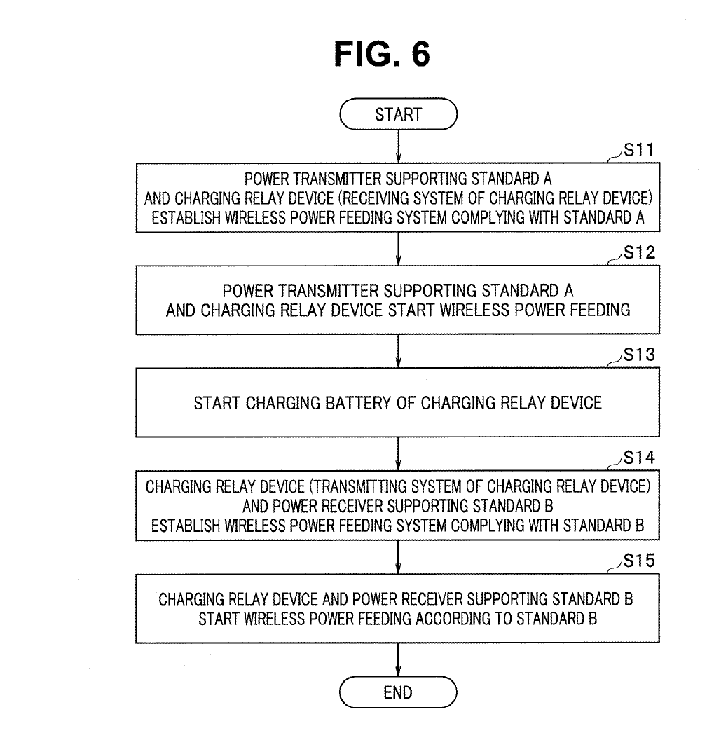

Charging relay processing of the charging relay device 4b configured as described above will be described next. FIG. 6 is a flowchart for explaining an example of flow of the charging relay processing by the charging relay device 4b of the second embodiment. Note that in the following description, the power receiver corresponds to the mobile terminal 2.

First, the power transmitter 3 supporting standard A and the charging relay device 4b (receiving system 11 of the charging relay device 4b) establish a wireless power feeding system complying with standard A (step S11). Then, the power transmitter 3 supporting standard A and the charging relay device 4b start wireless power feeding (step S12). Subsequently, charging of the battery 42 of the charging relay device 4b is started (step S13).

Then, the charging relay device 4b (transmitting system 13 of the charging relay device 4b) and the power receiver supporting standard B establish a wireless power feeding system complying with standard B (step S14). Finally, the charging relay device 4b and the power receiver supporting standard B start wireless power feeding according to standard B (step S15), and the processing is finished.

As described above, in the case of the charging relay device 4b provided with the battery 42, as described in the first embodiment, it is possible to wirelessly feed power to the power receiver supporting standard B from the power transmitter 3 supporting standard A by converting a communication protocol complying with standard A into a communication protocol complying with standard B. Further, when the charging relay device 4b is provided with the battery 42, it is possible to wirelessly feed power to the power receiver supporting standard A from the power transmitter 3 supporting standard A and wirelessly feed power from the battery 42 to power receivers other than the power receiver supporting standard A, so that it is possible to wirelessly feed power to power receivers supporting different standards without converting a communication protocol. Further, it is possible to wirelessly feed power to a power receiver supporting standard A and power receivers other than the power receiver supporting standard A at the same time without converting a communication protocol.

Note that when the battery 42 of the charging relay device 4b is sufficiently charged to perform wireless power feeding, in the charging relay processing in FIG. 6, processing in steps S14 and S15 may be performed first. By performing processing in this manner, it is possible to immediately start wireless power feeding between the battery 42 of the charging relay device 4b and the mobile terminal 2, so that it is possible to eliminate time loss dues to relay of charging by the charging relay device 4b.

Therefore, according to the charging relay device of the embodiment, as with the first embodiment, it is possible to enable wireless power feeding even among wireless power feeding devices supporting different standards and eliminate time loss due to relay of charging.

Note that, with regard to each step in the flowcharts in this specification, as long as it does not contradict the nature thereof, the order of carrying out the steps may be changed, a plurality of steps may be performed simultaneously, or the steps may be performed in a different order each time the process is carried out.

While certain embodiments have been described, these embodiments have been presented by way of example only, and are not intended to limit the scope of the inventions. Indeed, the novel apparatuses, methods and circuits described herein may be embodied in a variety of other forms; furthermore, various omissions, substitutions and changes in the form of the apparatuses, methods and circuits described herein may be made without departing from the spirit of the inventions. The accompanying claims and their equivalents are intended to cover such forms or modifications as would fall within the scope and spirit of the inventions.

What it claimed is:

1. A charging relay device comprising:
a power receiving unit configured to receive power according to a first standard;
a power transmitting unit configured to transmit power according to a second standard that is different from the first standard; and
a communication protocol converting unit configured to convert a communication protocol complying with the second standard into a communication protocol complying with the first standard.

2. The charging relay device according to claim 1,
wherein the communication protocol converting unit converts the communication protocol complying with the second standard of communication data received by the power transmitting unit into the communication protocol complying with the first standard, and
wherein the power receiving unit transmits communication data in the communication protocol complying with the first standard.

3. The charging relay device according to claim 2,
wherein the communication data is supply power information that is a request from a device to be charged.

4. The charging relay device according to claim 3,
wherein the power receiving unit transmits the communication data in the communication protocol complying with the first standard according to the supply power information to a power transmitter.

5. The charging relay device according to claim 1, further comprising a battery configured to be charged with power received at the power receiving unit.

6. The charging relay device according to claim 5, further comprising a charging control circuit configured to control charging to the battery.

7. The charging relay device according to claim 1,
wherein the power transmitting unit comprises a plurality of transmission coils configured to transmit power respectively according to standards different from each other.

8. The charging relay device according to claim 7,
wherein the plurality of transmission coils wirelessly feed power at the same time to a plurality of devices to be charged respectively supporting standards different from each other.

9. The charging relay device according to claim 1,
wherein the power receiving unit and the power transmitting unit are disposed on different faces of the charging relay device.

10. A charging relay method comprising:
receiving communication data in a communication protocol complying with a second standard from a device to be charged at a power transmitting unit; and
converting the communication protocol of the received communication data into a communication protocol complying with a first standard that is different from the second standard and transmitting the communication data from a power receiving unit to a power transmitter.

11. The charging relay device according to claim 10,
wherein the communication data is supply power information that is a request from the device to be charged.

12. The charging relay device according to claim 11,
wherein the communication data in the communication protocol complying with the first is transmitted from the power receiving unit to the power transmitter according to the supply power information.

13. The charging relay method according to claim 10,
wherein power according to the first standard is received at the power receiving unit from the power transmitter,
a battery is charged with the power received at the power receiving unit, and
the power charged in the battery is transmitted to the device to be charged.

14. The charging relay method according to claim 10,
wherein power is wirelessly fed at the same time to a plurality of devices to be charged supporting standards different from each other using a plurality of transmission coils capable of transmitting power according to standards different from each other.

15. The charging relay method according to claim 12,
wherein power according to the first standard is received at the power receiving unit from the power transmitter, and
power according to the second standard is transmitted in accordance with the supply power information from the power transmitting unit to the device to be charged.

16. The charging relay method according to claim 12,
wherein power according to the first standard is received at the power receiving unit from the power transmitter, and
power according to the second standard that exceeds power in accordance with the supply power information is transmitted from the power transmitting unit to the device to be charged.

17. A charging relay method comprising:
receiving power according to a first standard at a power receiving unit from a power transmitting unit;
charging a battery with the power received;
receiving communication data in a communication protocol complying with a second standard at the power transmitting unit from a device to be charged, and
transmitting the power charged in the battery to the device to be charged, by the power transmitting unit.

18. The charging relay device according to claim 17,
wherein the first standard and the second standard are different from each other.

19. The charging relay device according to claim 17,
wherein the communication data is supply power information that is a request from the device to be charged, and
power according to the second standard is transmitted in accordance with the supply power information from the power transmitting unit to the device to be charged.

20. The charging relay device according to claim 17,
wherein the communication data is supply power information that is a request from the device to be charged, and
power according to the second standard that exceeds power in accordance with the supply power information is transmitted from the power transmitting unit to the device to be charged.
